(19) United States
(12) Patent Application Publication
(10) Pub. No.: US 2010/0181212 A1
(43) Pub. Date: Jul. 22, 2010

(54) MONOLITHIC MATERIALS FOR GAS STORES

(76) Inventors: Matthias Koch, Wiesbaden (DE); Gerhard Jonschker, Heppenheim (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/376,620

(22) PCT Filed: Jul. 11, 2007
(86) PCT No.: PCT/EP07/06136

§ 371 Date: Feb. 6, 2009

(30) Foreign Application Priority Data
Aug. 9, 2006 (DE) 102006037194.1

(51) Int. Cl. B65B 3/00; B01J 20/26; F17C 11/00

(52) U.S. Cl. 206/7; 502/402

(57) ABSTRACT

The invention relates to supported metal-organic framework materials comprising a combination of metal-organic framework material (MOF) and open-pore polymer foams (polyHIPE), and to their preparation and use as gas storage material.

The invention relates to a supported metal-organic framework material comprising a combination of open-pore polymer foam (polyHIPE) and a metal-organic framework material (MOF), and to the preparation and use thereof as gas storage material.

The storage of gases, in particular hydrogen, is of growing economic importance. Materials which are able to adsorb the gases on a large surface allow the construction of gas tanks without high-pressure or cryotechnology. These are claimed to form the basis for the conversion of vehicles currently operated with liquid fuel to environmentally friendly or even environmentally neutral gaseous fuels. The gaseous fuels with the greatest existing and future economic and political potential have been identified as being natural gas/methane and hydrogen.

The state of the art in gas-operated vehicles today is pressurised storage in steel cylinders and to a small extent in composite cylinders. Storage of natural gas in CNG (compressed natural gas) vehicles takes place at a pressure of 200 bar. In most prototypes of hydrogen-operated vehicles, pressurised storage systems at 350 bar or to a small extent cryogenic liquid hydrogen systems at −253° C. (20 K) are used.

As future solution, pressure systems for 700 bar which have a volume-based storage density comparable to liquid hydrogen are already being developed. Common features of these systems are still low volume efficiency and high weight, which limits the range of the vehicles to about 350 km (CNG vehicles) or 250 km (hydrogen vehicles). Furthermore, the high energy consumption for compression and in particular for liquefaction represents a further disadvantage which reduces the possible ecological advantages of gas-operated vehicles. In addition, the tank design must take into account storage at very low temperatures (20 K) by means of extreme insulation. Since complete insulation cannot be achieved, a considerable leakage rate in the order of 1-2% per day must be expected for such tanks. From the above-mentioned energetic and economic (infrastructure costs) aspects, pressurised storage is regarded as the most promising technology for gaseous fuels natural gas (CNG) and later hydrogen for the foreseeable future.

An increase in the pressure level in the case of CNG to above 200 bar would only be imaginable with difficulty in technical and economic terms since an extensive infrastructure and fast-growing vehicle stock of at present about 50,000 cars in Germany already exist now. Potential solutions for increasing the storage capacity thus remain optimisation of the tank geometry (avoidance of individual cylinders, structure tank in “cushion form”) and an additional, supporting storage principle, such as adsorption.

This potential solution could also be applied to hydrogen, where even greater advantages would be expected than in the case of natural gas. The reason for this is the real gas behaviour of hydrogen (real gas factor Z>1), as a consequence of which the physical storage capacity only increases sub-proportionally with the pressure.

Chemical storage in metal hydride stores is already very far advanced. However, high temperatures arise during charging of the stores, which have to be dissipated in a short time during filling of the tank. Correspondingly high temperatures are necessary during discharge in order to expel the hydrogen from the hydrides. Both require the use of considerable amounts of energy for cooling/heating, which impairs the efficiency of the stores. These disadvantages are caused by the thermodynamics of storage. In addition, the kinetics of hydride-based hydrogen stores are poor, which increases the time needed for filling the tank and makes the provision of hydrogen during operation more difficult. Materials having faster kinetics are known (for example alanates), but they are pyrophoric, which limits use in motor vehicles.

Besides conventional pressurised storage, essentially three concepts for hydrogen storage are currently under discussion: cryostorage, chemical storage and adsorptive storage [see L. Zhou, Renew. Sust. Energ. Rev. 2005, 9, 395-408]. Cryostorage (liquid hydrogen) is technically complex and associated with high evaporation losses, while chemical storage using hydrides requires additional energy for decomposition of the hydride, which is frequently not available in the vehicle. An alternative is adsorption storage. Here, the gas is adsorbed in the pores of a nanoporous material. The density of the gas inside the pores is thus increased. In addition, desorption is associated with a self-cooling effect, which is advantageous for adsorptive cryostorage. However, the heat flows during adsorption and desorption are much smaller than in the case of hydrides and therefore do not represent a fundamental problem.

To date, porous materials, such as zeolites or active carbons, have traditionally been employed for gas storage. Owing to the low density of active carbons, however, only low energy densities are achieved.

Recently, remarkable results have been achieved using inorganic/organic hybrids, so-called metal-organic frameworks (MOFs), which leave the storage capacity of zeolites or active carbons far behind. MOFs are hybrid materials which consist of an inorganic cluster (determines the topology of the network) and an organic linker, which can be employed in a modular manner and allows pore size and functionality to be designed in a variable manner. Initial investigations of hydrogen storage using MOFs (for example MOF-5) originate from Yaghi et al. Science 2003, 300, 1127-1129.

EP-0 727 608 describes the use of organometallic complexes for the storage of gaseous C₁- to C₄-carbohydrates. However, the complexes disclosed therein are difficult to synthesise. Furthermore, the storage capacity of the materials described is low, if not too low, for industrial applications.

J. Am. Chem. Soc. 2004, 126, 5666-5667 describes so-called IRMOFs (isoreticular metal-organic frameworks), which consist, for example, of Zn₄O clusters and a linear dicarboxylate linker, such as naphthalene dicarboxylate (NDC). They enable storage of up to 2% of hydrogen and are produced in the form of a finely particulate powder. During filling of a tank, this powder has to be compacted or pressed, during which a significant part of the storage capacity is lost (up to one third).

In addition, the pressing hinders gas transport—the pores are less readily accessible. The filling and emptying of the tank is thus slowed. Furthermore, the material does not have a bimodal pore distribution of transport and storage pores, i.e. the MOFs do not have any transport pores (pore diameter 0.1 to 2 μm). A type of transport pores can only be established through the degree of compaction via the cavities between the particles.

The object of the present invention was therefore to develop a monolithic storage material which has transport and storage pores and can be installed in tanks in the form of blocks or cylinders and thus does not have the above-mentioned disadvantages.

Surprisingly, the present object is achieved by installing known metal-organic framework materials (MOFs) in open-pore polymer foams (so-called polyHIPEs), which serve as host material, or synthesising them therein.

The present invention thus relates to a supported metal-organic framework material comprising a combination of metal-organic framework material and open-pore polymer foams.

The term HIPE stands for high internal phase emulsion and describes any emulsion in which the disperse phase (here water) occupies a greater volume (usually more than 74% of the total volume) than the continuous phase (for example styrene or acrylic acid derivatives). On curing by polymerisation of the continuous phase, an open-pore polymer foam forms, which is then, strictly speaking, no longer an emulsion and is also referred to in the literature as “polyHIPE”.

The polyHIPEs are particularly suitable for this purpose since they are dimensionally stable, open-pore polymer foams which make up to 95% of the volume available as space in which MOFs can be formed. The size of the pores and the pore connections can, in accordance with the invention, be controlled via the synthesis parameters and adjusted in such a way that the MOFs formed therein cannot fall out. The latitude for adjustment of the pores is significantly greater here than in the case of similar inorganic systems, such as, for example, zeolites.

The polyHIPEs must be synthesised here in such a way that their pore size is optimised for use as host material. In addition, they must be constructed in such a way that their structure survives the synthesis of the MOFs.

Simple mixing, i.e. subsequent introduction of ready-synthesised MOFs into polyHIPEs, is not successful here since the powders are not incorporated into the polymer foams at all.

The polyHIPEs are therefore, in accordance with the invention, impregnated with the dissolved starting materials of the MOFs, giving supported metal-organic framework materials.

Subsequent gas transport through the pores is thus possible without hindrance, the MOFs formed therein are rapidly reached by the gas, and filling and emptying of the tanks is not hindered.

The open-pore polymer foams according to the invention are based on a water-in-oil emulsion whose aqueous phase occuoies more than 70% of the volume and whose oil phase comprises at least one polymerisable monomer. Preference is given here to the use of derivatives of acrylic acid and/or of styrene.

The metal-organic framework material (MOF) employed, which contains pores, comprises at least one metal ion and at least one at least bidentate organic compound, where said bidentate organic compound is bonded to said metal ion, preferably via a coordination bond. Such materials are known per se, for example U.S. Pat. No. 5,648,508; US 2004/0225134 A1; J. Sol. State Chem., 152 (2000), 3-20; Nature 402 (1999), 276 ff.; Topics in Catalysis 9 (1999), 105-111; Science 291 (2001), 1021-23. Cu-based MOFs are prepared, for example, in accordance with Kaskel et al., Microporous and Mesoporous Materials 73 (2004) 81-88.

With respect to the metallic component of the metal-organic framework material as is to be used for the purposes of the present invention, mention should be made, in particular, of the metal ions of the elements from groups Ia to VIa and Ib to VIb of the Periodic Table of the Elements. Particular mention should be made here of Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, TI, Si, Ge, Sn, Pb, As, Sb and Bi, where Zn, Cu, Ni, Pd, Pt, Ru, Rh and Co are particularly preferred. Zn and Cu ions are the most preferred.

With respect to the at least bidentate organic compound of the MOFs which must be capable of coordinating to the metal ion, all compounds which can be employed for this purpose and which meet the above-mentioned conditions, in particular which are at least bidentate, are conceivable in principle. The organic compound must have at least two centres which are capable of forming a coordinative bond to the materials, in particular to the metals from the above-mentioned groups. With respect to the at least bidentate organic compounds, particular mention should be made of substituted or unsubstituted, mono- or polynuclear aromatic di-, tri- or tetracarboxylic acids and substituted or unsubstituted aromatic di-, tri- or tetracarboxylic acids which comprise one or more rings and contain at least one hetero-atom. A particularly preferred ligand is trimesic acid (also known as benzenetricarboxylic acid (BTC)), and particularly preferred metal ions are, as already mentioned above, the Cu²⁺ and Zn²⁺ ions. The most preferred MOF according to the invention is Cu₃(BTC)₂.

The supported metal-organic framework materials according to the invention contain pores, in particular storage and transport pores, where storage pores are defined as pores which have a diameter of 0.1 to 4 nm. Transport pores are defined as pores which have a diameter of 0.1 to 2 μm. The presence of storage and transport pores can be checked by sorption measurements, with the aid of which the uptake capacity of the supported metal-organic framework materials for nitrogen at 77 K can be measured, to be precise in accordance with DIN 66131. In a preferred embodiment, the specific surface area, as calculated in accordance with the Langmuir model, is preferably greater than 1000 m²/g.

The supported metal-organic framework materials according to the invention also encompass the use of the more recent isoreticular metal-organic framework materials (IR-MOFs). Materials of this type have the same framework topology as one another, but different pore sizes and crystal densities. IR-MOFs of this type are described, inter alia, in J. Am. Chem. Soc. 2004, 126, 5666-5667 or M. Eddouadi et al., Science 295 (2002) 469, which are incorporated in their full scope into the context of the present application by way of reference.

The invention furthermore relates to a process for the preparation of supported metal-organic framework materials comprising the steps of:
a) preparation of an open-pore polymer foam via a water-in-oil emulsion whose aqueous phase occupies more than 70% of the volume and whose oil phase comprises at least one polymerisable monomer,
b) impregnation of the open-pore polymer foam with a solution of at least one substituted or unsubstituted aromatic polycarboxylic acid and an inorganic salt selected from elements from groups Ia to VIa and Ib to VIb of the Periodic Table and subsequent reaction of the starting materials to give the supported metal-organic framework material.

In a preferred embodiment, the open-pore polymer foam is prepared from a derivative of acrylic acid and/or of styrene.

In order to have higher affinity to the gases to be stored, the open-pore polymer foam may additionally comprise a nitrogen-containing monomer, preferably a pyridine derivative, such as, for example, vinylpyridine.

It is furthermore preferred in accordance with the invention for an unpolymerisable solvent (porogen) to be added to the oil phase of the open-pore polymer foam to be prepared. Toluene and/or hexane is (are) preferably employed here. This enables the porosity of the open-pore polymer foam to be increased.

In addition, it is preferred for the polyHIPE to be carbonised in a manner known to the person skilled in the art before synthesis of the MOF. This enables the porosity of the polymer foam to be increased and the surface area to be increased five to ten fold.

The present invention furthermore relates to a device for the accommodation and/or storage and/or release of at least one gas, comprising a supported metal-organic framework material consisting of a combination of metal-organic framework material and open-pore polymer foams. The device according to the invention may comprise the following further components:
a container which accommodates the metal-organic framework material;
an aperture for feed or discharge which allows at least one gas to enter or leave the device;
a gas-tight accommodation mechanism which is capable of keeping the gas within the container under pressure.

The present invention furthermore relates to a stationary, mobile or portable apparatus which encompasses the device according to the invention.

The present invention furthermore relates to the use of the metal-organic framework materials supported in accordance with the invention as gas storage material. In a preferred embodiment, the framework materials according to the invention are employed for the storage of hydrogen. They are more preferably employed for the storage of natural gas, preferably methane.

The following examples are intended to illustrate the present invention. However, they should in no way be regarded as limiting. All compounds or components which can be used in the preparations are either known and commercially available or can be synthesised by known methods. The temperatures indicated in the examples are always given in ° C. It furthermore goes without saying that, both in the description and in the examples, the added amounts of the components in the compositions always add up to a total of 100%. Percentage data given should always be regarded in the given connection. However, they usually always relate to the weight of the part- or total amount indicated.

### EXAMPLES

### Example 1.1

### Synthesis of Copper Trimesic Acid Cu₃(BTC)₂

10.387 g of copper(II) nitrate trihydrate and 5 g of trimesic acid (BTC) are dissolved in 250 ml of solvent mixture comprising DMF, ethanol and water and stirred for 10 minutes.

### Example 1.2

### Preparation of a Polymer Body (polyHIPE) from a W/O Emulsion by Emulsion Polymerisation

0.209 ml (1.46 mmol) of divinylbenzene, 0.30 g (0.70 mmol) of Span 80 (Fluka Art. No. 85548) and 0.66 ml (5.81 mmol) of styrene are introduced into a 30 ml PE bottle. An aqueous solution is prepared from 45 mg of potassium peroxodisulfate, 353.26 mg of potassium sulfate are dissolved therein, and 30 ml thereof are introduced dropwise into the bottle over the course of 15 min. The mixture is stirred during the introduction. A white, foamy emulsion forms. The mixture is subsequently heated to 60° C. in an oil bath and allowed to polymerise for about 24 h. The PE bottle is then cut open, and the white and hard polymer body (polyHIPE) formed is worked up by purification and drying.

### Example 1.3

### Incorporation of the Cu₃(BTC)₂ into the Polymer Body

The dry polymer body is evacuated in a vessel in order to achieve better filling of the pores with the solution prepared in Example 1.1. The solution is let into the evacuated vessel via a stopcock, after which the pores of the polymer body fill therewith. The polymer body is introduced into an appropriate plastic vessel, and this is heated in the sealed state in a drying cabinet at 85° C. for 20 h. The mixture is then allowed to cool for 5 h, and the Cu₃(BTC)₂ is obtained as a pale-blue compound in the pores of the polymer body.

### INDEX OF FIGURES

FIG. 1: shows an SEM photograph of the polymer foam before impregnation

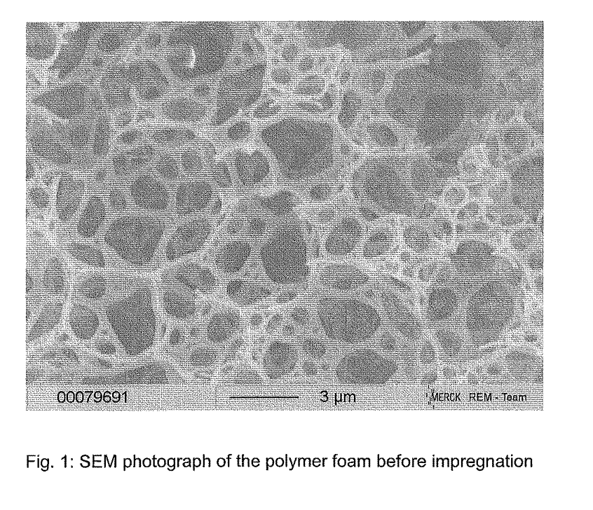

FIG. 2: shows an SEM photograph of MOFs formed inside the polyHIPE (after impregnation)

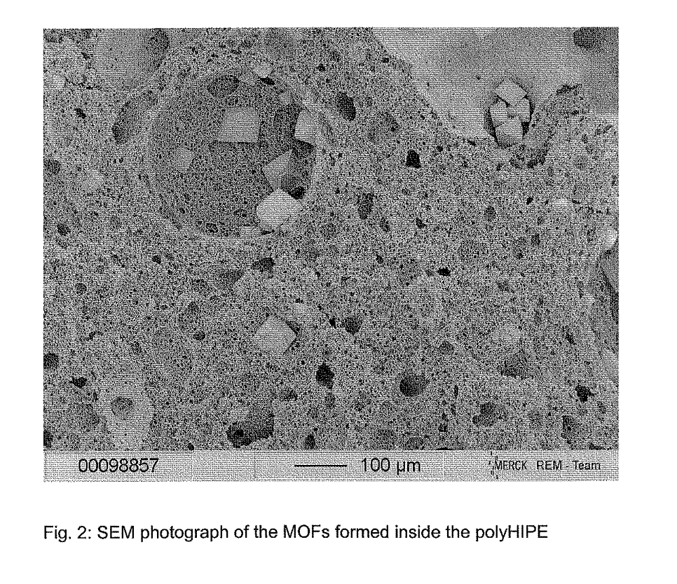

1. Supported metal-organic framework materials, characterised in that they comprise a combination of metal-organic framework material and open-pore polymer foams.

2. Supported metal-organic framework materials according to claim 1, characterised in that the metal-organic framework material comprises at least one metal ion and at least one at least bidentate organic compound which is bonded to said metal ion.

3. Supported metal-organic framework materials according to claim 1, characterised in that the metal-organic framework materials comprise metal ions selected from elements from groups Ia to VIa and Ib to VIb of the Periodic Table.

4. Supported metal-organic framework materials according to claim 1, characterised in that the metal-organic framework materials consist of zinc- or copper-based metal-organic framework materials.

5. Supported metal-organic framework materials according to claim 1, characterised in that the at least bidentate organic compound is selected from substituted or unsubstituted aromatic polycarboxylic acids which comprise one or more rings and substituted or unsubstituted aromatic polycarboxylic acids which contain at least one heteroatom and may comprise one or more rings.

6. Supported metal-organic framework materials according to claim 1, characterised in that the open-pore polymer foams are based on a water-in-oil emulsion whose aqueous phase occuoies more than 70% of the volume and whose oil phase comprises at least one polymerisable monomer.

7. Supported metal-organic framework materials according to claim 6, characterised in that the open-pore polymer foams consist of derivatives of acrylic acid and/or of styrene.

8. Process for the preparation of supported metal-organic framework materials comprising the steps of:
a) preparation of an open-pore polymer foam via a water-in-oil emulsion whose aqueous phase occuoies more than 70% of the volume and whose oil phase comprises at least one polymerisable monomer,
b) impregnation of the open-pore polymer foam with a solution of at least one substituted or unsubstituted aromatic polycarboxylic acid and an inorganic salt selected from elements from groups Ia to VIa and Ib to VIb of the Periodic Table and subsequent reaction of the starting materials to give the supported metal-organic framework material.

9. Process according to claim 8, characterised in that the open-pore polymer foam is prepared from a derivative of acrylic acid and/or of styrene.

10. Process according to claim 8, characterised in that the inorganic salt employed in step b) is a copper or zinc salt.

11. Process according to claim 8, characterised in that the aromatic polycarboxylic acid employed in step b) is trimesic acid.

12. Process according to claim 8, characterised in that the supported metal-organic framework material is additionally carbonised.

13. Device for the accommodation and/or storage and/or release of at least one gas, comprising a supported metal-organic framework material consisting of a combination of metal-organic framework material and open-pore polymer foams.

14. Device according to claim 13, characterised in that it additionally comprises a container which accommodates the supported metal-organic framework material;
an aperture or outlet which enables the at least one gas to enter or leave the device;
a gas-tight accommodation mechanism which is capable of keeping the gas within the container under pressure.

15. Stationary, mobile or portable apparatus containing a device according to claim 13.

16. Gas storage material comprising supported metal-organic framework materials consisting of a combination of metal-organic framework material and open-pore polymer foams.

17. Material according to claim 16 for the storage of hydrogen.

18. Material according to claim 16 for the storage of natural gas, preferably methane.
